(19) United States
(12) Patent Application Publication
(10) Pub. No.: US 2003/0170905 A1
(43) Pub. Date: Sep. 11, 2003

(54) Diagnostic beads for the detection of blood in animal excreta and a method for production thereof

(76) Inventors: Alexander Kamyshny, Jeruselum (IL); Shlomo Magdassi, Jeruselum (IL); Samih Mishirqi, Nazareth (IL)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/090,008

(22) Filed: Mar. 5, 2002

(51) Int. Cl. G01N 21/00; G01N 31/22

(52) U.S. Cl. 436/164; 436/166; 436/169; 422/55; 422/56

(57) ABSTRACT

Diagnostic beads for the detection of occult blood in animal excreta, especially for use in a cat litter. The beads comprise a particulate material and a detection composition attached to the particulate material. The detection composition comprises a chromogen, a peroxide, an enhancer, a stabilizer, and a binder, the chromogen being selected to react with occult blood in the animal excreta so as to produce a visible and immediate color change when excreta containing blood comes into contact with the diagnostic beads

### FIELD OF THE INVENTION

The present invention relates to the field of diagnostic tools used in the detection of diseases. More specifically, the present invention relates to diagnostic beads coated or impregnated with a detection composition for the detection of blood in animal excreta. The diagnostic beads are especially useful for animal litters.

### BACKGROUND OF THE INVENTION

Various different testing vehicles have been developed over the passed few decades for the detection of occult blood in cat excreta. For example, a variety of “paper strip” tests are known in the art and are available on the market. To use, the pet owner applies the paper strips to the cat litter and, if and when the paper strips come into contact with urine containing blood, the paper strips change color. The paper strips have certain drawbacks, however. Firstly, they are not homogeneously located throughout the cat litter, but only on the top surface. Therefore, if the cat digs in the litter before urinating, the paper strips might not contact the urine. Furthermore, the paper strips have a tendency to fold and may be inconvenient to handle. When using a commercially available paper strip product that is sold separately from the cat litter (for example, paper strips produced and marketed by the Ralston Purina Company), the user has to put the strips on top of the cat litter and spread the strips homogeneously in order to obtain reliable results. Furthermore, gloves need to be worn when handling the paper strip product to avoid touching the product with bare hands. A further problem is the rapid fading of the color of the paper strip, which limits the evaluation of the detector strips to a short time interval. It will become apparent that this type of product has many disadvantages when compared to the product of the present invention.

Many of the testing vehicles available for detecting blood in animal excreta take advantage of the oxidation of a chromogen that occurs when hemoglobin contacts said chromogen. With the proper detection composition, a color change that accompanies the chemical reaction can be readily seen and indicate to a pet owner that his cat may have a urinary tract infection or other disease. For example, U.S. Pat. Nos. 5,468,450, 4,063,894, 5,178,831, and 5,183,742, all relate to testing systems that utilize the aforementioned chemical reactions. However, none of these inventions, nor those disclosing the above-mentioned paper strips (for example, U.S. Pat. No. 5,830,765), satisfactorily provides a direct and efficient testing system for detecting occult blood in animal excreta. The results of such tests can often be unclear to a pet owner, due to color migration or false positive results. Moreover, the testing systems are often inconvenient or messy to use, are not efficient in absorbing the animal excreta, and the color change may quickly fade, thus not providing accurate results.

It is therefore the primary object of the present invention to provide a diagnostic tool for detecting blood in animal excreta (urine or feces) that utilizes beads having a size and shape similar to that of the cat litter product. In some cases, the invention utilizes the very components from which the animal litter is made, without requiring any additional vehicles (as testing systems of the prior art do require). The litter absorber, in the form of diagnostic beads, is used to screen for the presence of blood. This new technology allows for the immediate and direct detection of blood in animal excreta without any uncertainty about the reliability of the results. The detection composition used in the diagnostic beads ensures against false positive results and against color migration. Moreover, the diagnostic beads are homogeneously distributed throughout the cat litter, to ensure that each time the pet eliminates in the litter, excreta contacts the diagnostic beads. The diagnostic beads may be made available as part of a premixed litter. Thus, the user uses the litter as a normal litter, and need not purchase or add any additional product. As part of a premixed litter, the presence of a problem can be detected at a very early stage, which is critical for quick treatment and recovery. Other objects and advantages of the present invention over the technology currently available in the art will become readily apparent from the summary of the invention and detailed description of the invention that follow.

### SUMMARY OF THE INVENTION

The present invention relates to a new diagnostic tool for the detection of occult blood in animal excreta. Specifically, the present invention provides for diagnostic beads that are especially for use in animal litters. The diagnostic beads of the present invention are easy to use, and highly efficient, providing a reliable result in a manner of seconds or minutes. The beads are chemically designed so as to eliminate the possibility for false positive reading. There is no color change unless there is blood present in the excreta, and there is no color migration (so that the color change, if any, can be readily and easily detected). The diagnostic beads of the present invention provide a way for pet owners to regularly monitor the health of their cat without having to take the cat to a veterinarian. This saves time, money, and the inconvenience of trying to get urine samples from the cat.

While the present invention will be described in the context of use for a cat litter, it should be appreciated that the diagnostic beads may be utilized in other animal litters as well, for example, a dog litter.

In the context of the present invention, the term “diagnostic beads” refer to small granule-like particles, having a diameter of 2-5 mm, that are either coated or impregnated with a detection composition for detecting blood in cat excreta. “Particulate material” refers to the particles or granules from which the diagnostic beads are produced, which may include wood-based beads, coated wood-based beads, “eco-granules” (a wooden based-product currently used in some cat litters, produced by Cycle Group Inc.), silica gel particles, clay beads, or any other suitable organic or inorganic particle. A method for the preparation of wood-based beads for use as a particulate material in the present invention is disclosed in U.S. Pat. No. 6,030,565, entitled, “Method for Manufacturing an Agglomerate” and in U.S. patent application Ser. No. 09/497,337, entitled, “Method of Coating Granulated Material”.

The present invention relates to diagnostic beads for the detection of occult blood in animal excreta, especially for use in an animal litter. The diagnostic beads comprise a particulate material and a detection composition attached to the particulate material (either coated on the surface or impregnated into the particulate material, depending on the type of particulate material used and the method of application of the detection composition). The detection composition comprises a chromogen, a peroxide, an enhancer, a stabilizer, and a binder. In some preferred embodiments, the detection composition also comprises at least one additive, for example, metal sequestrates wetting agents. The chromogen is selected to react with occult blood in the animal excreta so as to produce a visible and immediate color change when excreta containing blood comes into contact with the diagnostic beads.

According to preferred embodiments of the present invention, the particulate material comprises a cat litter-absorbent material (meaning that it is capable of absorbing the cat excreta). In other preferred embodiments, the particulate material comprises inorganic particles having the size and shape of the cat litter(-absorbent) material, thereby avoiding the possibility of segregation of the diagnostic beads from the cat litter product (as it can occur with paper strips).

Further according to preferred embodiments of the present invention, the particulate material is selected from the group consisting of: wood-based beads, wood-based beads coated with titanium dioxide, wood-based beads coated with calcium carbonate, wood-based beads coated with starch, silica gel beads, quartz beads, polystyrene beads, alumino-silicates (such as perlite) and cellulose beads. Any other suitable organic or inorganic particle may also be used.

Additionally according to preferred embodiments of the present invention, the chromogen is 3,3 5,5-tetramethyl benzidine.

Still further according to preferred embodiments of the present invention, the enhancer is 6-methoxyquinoline.

Moreover according to preferred embodiments of the present invention, the peroxide is cumene hydroperoxide. Other appropriate peroxides which are stable for prolonged periods of time may also be used, as is known in the art.

Further according to preferred embodiments of the present invention, the stabilizer is ascorbic acid. Other appropriate antioxidants such as BHA or BHT may also be employed, as is known in the art.

Additionally according to preferred embodiments of the present invention, the diagnostic beads further comprise at least one additional binder and an inorganic filler. The organic filler is preferably selected from at least one of calcium carbonate and alumina. Preferably, the binder is a starch derivative or a polymeric material capable of adhering onto the diagnostic beads.

The present invention also relates to an animal litter for the detection of blood in animal excreta comprising diagnostic beads, as defined above. It is appreciated that, in contrast to the diagnostic tests already known in the art, the beads of the present invention are part of the animal litter itself and not require any additional vehicle for carrying out the diagnostic test. Since the diagnostic beads are part of the animal litter, the animal litter provides a way to detect any problems at the very early stages, which is critical for treatment and recovery. Preferably, the litter comprises 1-100% diagnostic beads. More preferably, the litter comprises 5-10% diagnostic beads. Preferably, the litter is a cat litter.

The present invention further relates to a method for producing diagnostic beads useful for the detection of occult blood in animal excreta, comprising producing a detection composition and applying said detection composition to a particulate material. The detection composition comprises a chromogen, a peroxide, an enhancer, a stabilizer, and a binder. In some preferred embodiments, the detection composition also comprises at least one additive, for example, metal sequestrates wetting agents. The chromogen is selected to react to occult blood in animal excreta so as to produce a visible color change when excreta containing blood comes into contact with the diagnostic beads.

According to preferred embodiments of the present invention, the particulate material comprises a cat litter-absorbent material. In other preferred embodiments, the particulate material comprises inorganic particles having the size and shape of the cat litter(-absorbent) material, thereby avoiding the possibility of segregation of the diagnostic beads from the cat litter product.

Further according to preferred embodiments of the present invention, the particulate material is selected from the group consisting of: wood-based beads, wood-based beads coated with titanium dioxide, wood-based beads coated with calcium carbonate, wood-based beads coated with starch, silica gel beads, quartz beads, polystyrene beads, alumino-silicates (such as perlite), clay, and cellulose beads.

Additionally according to preferred embodiments of the present invention, the chromogen is 3,3 5,5-tetramethylbenzidine.

Still further according to preferred embodiments of the present invention, the enhancer is 6-methoxyquinoline.

Moreover according to preferred embodiments of the present invention, the peroxide is cumene hydroperoxide. Other appropriate peroxides which are stable for prolonged periods of time may also be used, as is known in the art.

Further according to preferred embodiments of the present invention, the stabilizer is ascorbic acid. Other appropriate antioxidants such as BHA or BHT may also be employed, as is known in the art.

Additionally according to preferred embodiments of the present invention, the detection composition is applied to the particulate material as a dry powder.

Still further according to preferred embodiments of the present invention, the detection composition is applied to the particulate material as a liquid spray.

Moreover according to preferred embodiments of the present invention, the step of applying the detection composition comprises combining the detection composition with a binder and a filler to produce a powder, moistening the particulate material, and coating the particulate material with the powder in a coating pan.

Further according to preferred embodiments of the present invention, the binder comprises a starch derivative or a polymeric material capable of adhering onto the diagnostic beads. The filler is preferably comprised of alumina and calcium carbonate. Preferably, the binder further comprises carboxymethyl cellulose.

Additionally according to preferred embodiments of the present invention, the step of applying the detection composition comprises dissolving the detection composition in a suitable solvent such as alcohol (ethanol or methanol) combined with sodium hydroxide solution and spraying the resultant solution onto the particulate material. Another way to apply the detection composition is to mix all the detection composition components in dry powder, and coat the particulate material with the dry powder using an appropriate method, such as that described in U.S. patent application Ser. No. 09/497,337, entitled, “Method of Coating Granulated Material.”

The particulate material may be coated through any other appropriate method such as spraying, coating, air suspension technology, spinning disk coating, or seed coating technology which are based on spraying the coating on the particulate material when said particulate material is being rotates in the horizontal and/or vertical direction. Such coating technologies are described in “Microencapsulation and Particle Coating”, R. E. Sparks, The Center for Professional Advancement, 1999.

The present invention also relates to a method for producing diagnostic beads useful for the detection of occult blood in animal excreta, comprising producing a detection composition, combining the detection solution with a particulate material and at least one binder, and producing beads through a granulation process. The detection composition comprises a chromogen, a peroxide, an enhancer, a stabilizer, a binder, and preferably, at least one additive, as described above. The chromogen is selected to react to occult blood in animal excreta so as to produce a visible color change when excreta containing blood comes into contact with the diagnostic beads.

According to preferred embodiments of the present invention, the particulate material is selected from the group consisting of: wood-based beads, wood-based beads coated with titanium dioxide, wood-based beads coated with calcium carbonate, silica gel beads, quartz beads, polystyrene beads, alumino-silicates (such as perlite), clay, and cellulose beads. It is appreciated that other appropriate organic and inorganic particles may be used.

Further according to preferred embodiments of the present invention, the binder comprises a starch derivative, carboxymethyl cellulose, and polyvinyl pyrrolidone or other polymeric material capable of adhering to the particulate material.

### DETAILED DESCRIPTION OF THE INVENTION

The invention is now described with reference to the following examples. The examples are provided for the purposes of clarification only and are in no way meant to limit the scope of the invention. The examples disclose methods for the production of diagnostic beads for the detection of occult blood in animal excreta, according to certain preferred embodiments of the present invention. It will be apparent to those skilled in the art that many modifications may be made to the procedures described below, without departing from the scope of the invention, as set out in the claims.

In preferred embodiments of the present invention, the following detection composition is used, for coating or impregnation into particulate material, for the production of the diagnostic beads of the present invention. Unless it is otherwise indicated, the beads used in the examples were wood-based beads (preferably said beads are made according to the method disclosed in U.S. patent application Ser. No. 09/497,337).

Detection Composition:

3 g polyvinyl pyrrolidone

1.4 g sodium hydroxide

4.23 g citric acid

2 mg ascorbic acid

0.1 g EDTA disodium salt

0.075 g tartrazine

0.2 g dioctyl sulfosuccinate, sodium salt (AOT)

0.23 g cumene hydroperoxide

0.3 g 3,3 5,5-tetramethyl benzidine

0.2 g 6-methoxyquinoline

The above ingredients were thoroughly grounded in a porcelain mortar until a homogenous powder (hereinafter referred to as the “detection composition”) was achieved.

### EXAMPLE 1

The above detection composition was mixed with a binder and inorganic powder filler in the weight ratio of 1:1:8 (detection compositon:binder:filler) to produce 100 g total (suitable for coating 1 kg of beads). The binder comprised a mixture of starch derivatives and the filler comprised alumina and calcium carbonate. The resultant dry mixture was ground and used for coating beads. To coat, beads were moistened with water, and rolled in a coating pan containing the dry mixture.

### EXAMPLE 2

The detection composition was mixed with a binder (same as in Example 1), CMC (carboxymethyl cellulose, sodium salt) and inorganic powder filler (same as in Example 1) in the weight ratio of 1:1:1:7 (detection composition:binder:CMC:filler). The mixture was ground and coating of beads was performed as in Example 1.

### EXAMPLE 3

The detection composition was dissolved in a solution containing 65 ml methanol (or ethanol), 10 ml water and 35 ml 1M NaOH. The resulting solution was sprayed onto wooden beads. Some of the beads were pre-coated with titanium dioxide, or calcium carbonate or other white filler. The diagnostic beads were dried at 50° C.

### EXAMPLE 4

The detection composition was dissolved in a solution containing 65 ml methanol (or ethanol), 10 ml water and 35 ml 1M NaOH. The resulting solution was sprayed onto a mixture containing wood powder, binder (comprising starch derivatives) and CMC in a weight ratio of 1:1:1 (wood powder:binder:CMC). The resultant wet mixture was used to form beads through a granulation process, in which the wet mixture was squeezed through small holes into a heated rotating pan. In the pan, excess liquid was evaporated, leaving only the diagnostic beads. Alternatively, the beads could be produced through an aggolmeration process in which the detection composition solution is combined with a dry mixture of the wood powder, binder, and CMC in a rotating pan and agglomerated.

### EXAMPLE 5

3,3 5,5-tetramethyl benzidine, hydrochloride was dissolved in water at a concentration of 3 mg/ml. 5 ml of solution was added to 2 g cation exchanger (Dowex) (alternatively, microgranular CMC can be used here). After 1 hour of incubation, the cation exchanger (or CMC) was separated from solution, washed with distilled water and mixed with a starch binder (in a 1:1 weight ratio). Using this method, the salt of 3,3 5,5-tetramethyl benzidine was immobilized on the particles of the cation exchangers. Titania-coated wood-based beads were then coated by the cation exchanger/starch mixture, dried at 50° C. and subsequently sprayed with the detection composition. In this example, however, the original detection composition did not include tetramethyl benzidine. Prior to spraying, the detection composition was dissolved in a solution of methanol, water and sodium hydroxide, as in Example 3. Following spraying, the beads were again dried at 50° C.

### EXAMPLE 6

Beads were sprayed by a solution of cumene hydroperoxide (23 mg/ml) and Aerosol OT (2 mg/ml) in methanol/water (6:4 weight ratio). Then, the beads were moistened and coated with a dry mixture containing the detection composition (not including cumene hydroperoxide), starch binder, and alumina filler (1:1:8 weight ratio), as in Example 1. The coated beads were dried at 50° C.

### EXAMPLE 7

The same procedure as in Example 2 was performed, but instead of using wooden beads, silica gel particles were used.

### EXAMPLE 8

The same procedure as in example 4, but the resulting solution was sprayed over wood-based granules.

### EXAMPLE 9

The same procedure in example 8, but the solution was sprayed over Perlite granules.

To test the effectiveness of the diagnostic beads, several drops of a hemoglobin solution were pipetted onto the coated beads. A change of color from yellow to blue-green was observed within 10 seconds-2 minutes, depending on the concentration of the hemoglobin solution used. The diagnostic beads in Example 1 were suitable for the detection of hemoglobin at concentrations of 10 mg/l (corresponding to 30-60 erythrocytes/mu.1 of body fluid, e.g. urine) and above. The diagnostic beads produced in Examples 2-7 were all suitable for detecting hemoglobin at concentrations of 1 mg/ml (corresponding to 30-60 erythrocytes/mu.1 of body fluid, e.g. urine).

1. Diagnostic beads for the detection of occult blood in animal excreta, especially for use in an animal litter, comprising a particulate material and a detection composition attached to said particulate material, wherein the detection composition comprises a chromogen, a peroxide, an enhancer, a stabilizer, and a binder, said chromogen being selected to react with occult blood in the animal excreta so as to produce a visible and immediate color change when excreta containing blood comes into contact with said diagnostic beads.

2. Diagnostic beads according to claim 1, wherein the particulate material comprises a cat litter-absorbent material.

3. Diagnostic beads according to claim 1, wherein the particulate material comprises a material having the shape and size of the cat litter material.

4. Diagnostic beads according to claim 1, wherein the particulate material is selected from the group consisting of: wood-based beads, wood-based beads coated with titanium dioxide, wood-based beads coated with calcium carbonate, wood-based beads coated with starch, silica gel beads, quartz beads, polystyrene beads, alumino silicates, clay and cellulose beads.

5. Diagnostic beads according to claim 1, wherein the chromogen is 3,3 5,5-tetramethylbenzidine.

6. Diagnostic beads according to claim 1, wherein the enhancer is 6-methoxyquinoline.

7. Diagnostic beads according to claim 1, wherein the peroxide is cumene hydroperoxide.

8. Diagnostic beads according to claim 1, wherein the stabilizer is ascorbic acid.

9. Diagnostic beads according to claim 11, wherein the binder is a starch derivative.

10. Diagnostic beads according to claim 1, wherein the binder comprises an organic polymer capable of adhering to the particulate material.

11. Diagnostic beads according to claim 9, wherein the organic polymer material is selected from the group consisting of polyvinyl pyrrolidone, carboxymethyl cellulose, ethyl cellulose, and acrylic latex.

12. Diagnostic beads according to claim 1, further comprising at least one additional binder and an inorganic filler.

13. Diagnostic beads according to claim 11, wherein the organic filler is selected from at least one of calcium carbonate and alumina.

14. Diagnostic beads according to claim 1, further comprising at least one additive.

15. Diagnostic beads according to claim 14, wherein the additive is selected from the group consisting of wetting agents or metal ion sequestrants.

16. An animal litter for the detection of blood in animal excreta comprising diagnostic beads, as defined in any one of claims 1-15.

17. An animal litter according to claim 16, comprising 1-100% diagnostic beads.

18. An animal litter according to claim 16, comprising 5-10% diagnostic beads.

19. An animal litter according to claim 16, wherein the animal litter is a cat litter.

20. A method for producing diagnostic beads useful for the detection of occult blood in animal excreta, comprising producing a detection composition and applying said detection composition to a particulate material, wherein the detection composition comprises a chromogen, a peroxide, an enhancer, a stabilizer, and a binder, said chromogen being selected to react to occult blood in animal excreta so as to produce a visible color change when excreta containing blood comes into contact with said diagnostic beads.

21. A method according to claim 20, wherein the particulate material comprises a cat litter-absorbent material.

22. A method according to claim 20, wherein the particulate material comprises a material having the shape and size of the cat litter material.

23. A method according to claim 20, wherein the particulate material is selected from the group consisting of: wood-based beads, wood-based beads coated with titanium dioxide, wood-based beads coated with calcium carbonate, silica gel beads, quartz beads, polystyrene beads, alumino silicates, clay and cellulose beads.

24. A method according to claim 20, wherein the chromogen is 3,3 5,5-tetramethylbenzidine.

25. A method according to claim 20, wherein the enhancer is 6-methoxyquinoline.

26. A method according to claim 20, wherein the peroxide is cumene hydroperoxide.

27. A method according to claim 20, wherein the stabilizer is ascorbic acid.

28. A method according to claim 20, wherein the binder comprises a starch derivative.

29. A method according to claim 20, wherein the binder comprises an organic polymer capable of adhering to the particulate material.

30. A method according to claim 29, wherein the organic polymer material is selected from the group consisting of polyvinyl pyrrolidone, carboxymethyl cellulose, ethyl cellulose, and acrylic latex.

31. A method according to claim 20, wherein the detection composition is applied to the particulate material as a dry powder.

32. A method according to claim 20, wherein the detection composition is applied to the particulate material as a liquid spray.

33. A method according to claim 20, wherein the step of applying the detection composition comprises combining said detection composition with a binder and a filler to produce a powder, moistening the particulate material, and coating said particulate material with said powder.

34. A method according to claim 33, wherein the binder comprises a starch derivative and the filler is comprised of alumina and calcium carbonate.

35. A method according to claim 33, wherein the binder further comprises carboxymethyl cellulose.

36. A method according to claim 20, wherein the step of applying the detection composition comprises dissolving said detection composition in an alcohol and sodium hydroxide solution and spraying the resultant solution onto said particulate material.

37. A method according to claim 20, wherein the diagnostic beads further comprises at least one additive.

38. A method according to claim 37, wherein the additive is selected from the group consisting of wetting agents or metal ion sequestrants.

39. A method for producing diagnostic beads useful for the detection of occult blood in animal excreta, comprising producing a detection composition, combining said detection solution with a particulate material and at least one binder, and producing diagnostic beads through a granulation process, wherein the detection composition comprises a chromogen, a peroxide, an enhancer, a stabilizer, and a binder, said chromogen being selected to react to occult blood in animal excreta so as to produce a visible color change when excreta containing blood comes into contact with said diagnostic beads.

40. A method according to claim 39, wherein the particulate material is selected from the group consisting of: wood-based beads, wood-based beads coated with titanium dioxide, wood-based beads coated with calcium carbonate, wood-based beads coated with starch, silica gel beads, quartz beads, polystyrene beads, alumino silicates, clay and cellulose beads.

41. A method according to claim 39, wherein the particulate material comprises a cat litter-absorbent material.

42. A method according to claim 39, wherein the particulate material comprises a material having the shape and size of the cat litter material.

43. A method according to claim 39, wherein the chromogen is 3,3 5,5-tetramethylbenzidine.

44. A method according to claim 39, wherein the enhancer is 6-methoxyquinoline.

45. A method according to claim 39, wherein the peroxide is cumene hydroperoxide.

46. A method according to claim 39, wherein the stabilizer is ascorbic acid.

47. A method according to claim 39, wherein the binder comprises an organic polymer capable of adhering to the particulate material.

48. A method according to claim 47, wherein the organic polymer material is selected from the group consisting of polyvinyl pyrrolidone, carboxymethyl cellulose, ethyl cellulose, and acrylic latex.

49. A method according to claim 39, wherein the diagnostic beads further comprise at least one additive.

50. A method according to claim 49, wherein the additive is selected from the group consisting of wetting agents or metal ion sequestrants.
